(19) United States
(12) Patent Application Publication
(10) Pub. No.: US 2016/0301580 A1
(43) Pub. Date: Oct. 13, 2016

(54) Service Testing Method, Device, and System, Network Node, and Quality Processing Node

(71) Applicant: Huawei Technologies Co., Ltd., Shenzhen (CN)

(72) Inventors: Jiang Li, Moscow (RU); Li Yang, Shanghai (CN); Weiguo Niu, Shenzhen (CN)

(21) Appl. No.: 15/184,811

(22) Filed: Jun. 16, 2016

Related U.S. Application Data
(63) Continuation of application No. PCT/CN2013/089677, filed on Dec. 17, 2013.

(51) Int. Cl. H04L 12/24; H04L 12/26; H04W 24/06

(52) U.S. Cl. CPC H04L 41/5038; H04W 24/06; H04L 43/50

(57) ABSTRACT

A service testing method, device, and system, a network node, and a quality processing node, are provided. A service request initiation device generates a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node.

### CROSS-REFERENCE TO RELATED APPLICATIONS

This application is a continuation of International Application No. PCT/CN2013/089677, filed on Dec. 17, 2013, which is hereby incorporated by reference in its entirety.

### TECHNICAL FIELD

Embodiments relate to the field of network testing technologies, and in particular, to a service testing method, device, and system, a network node, and a quality processing node.

### BACKGROUND

As mobile broadband (“MBB” for short) and intelligent user equipment develop rapidly, service types of user applications are becoming diversified, and users are attaching growing importance to service quality. Good service quality can improve user satisfaction and loyalty, retain high-value users, and bring in higher revenue. Conversely, poor service quality causes user churn. Therefore, all service providers perform corresponding service tests.

Currently in the industry, after network deployment is completed, a manual dialing test method is usually used to test a network service. In the manual dialing test method, a tester initiates a service request by using user equipment (“UE” for short), then obtains a service acknowledge sent by a server, and then obtains service running information such as a start time and an arrival time of the service request and the service acknowledge in transmission on a network.

During implementation of the present invention, the inventor finds that the prior art has at least the following problems.

Manual involvement is required in this manual dialing test, which is often labor-consuming. In addition, in this manual dialing test, usually only a start time and an arrival time can be obtained, a running status of a network service at another location on a network cannot be reflected, and a test result is inadequate.

### SUMMARY

To avoid a problem in the prior art when a manual dialing test is adopted, time and energy are wasted, a status of running, at another location on a network, of a network service cannot be reflected, and a test result is inadequate, embodiments of the present invention provide a service testing method, device, and system, a network node, and a quality processing node. The technical solutions are as follows.

According to an aspect, an embodiment provides a service testing method. The method includes: generating, by a service request initiation device, a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node. The method also includes sending, by the service request initiation device, the service request.

In an implementation manner of this embodiment, the test indication information includes a first test identifier or a second test identifier. The first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node. The second test identifier is used to instruct each of the at least one network node to send the service running information to the service quality processing node by using an interface between each of the at least one network node and the service quality processing node.

In another implementation manner of this embodiment, the test indication information includes a network node type that is used to instruct the at least one network node corresponding to the network node type to send the service running information to the service quality processing node.

In another implementation manner of this embodiment, the test indication information includes: a service message type, where the service message type is used to instruct the at least one network node to send the service running information corresponding to the service message type to the service quality processing node, and the service running information corresponding to the service message type includes a time point at which a service message of the service message type arrives at the at least one network node.

According to another aspect, an embodiment further provides a service testing method. The method includes receiving, by at least one network node during running of a test service, a service request of the test service, where the service request includes test indication information, the test indication information is used to instruct the at least one network node to send service running information of the test service to a service quality processing node, and the service running information includes a time point at which a service message of the test service arrives at the at least one network node or a time point at which a service message of the test service is sent by the at least one network node. The method also includes sending, by the at least one network node in response to the service request, the service running information to the service quality processing node during running of the test service.

In an implementation manner of this embodiment, the test indication information includes a first test identifier or a second test identifier, where the first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node; and the second test identifier is used to instruct each of the at least one network node to send the service running information to the service quality processing node by using an interface between each of the at least one network node and the service quality processing node. When the test indication information is the first test identifier, the sending, by the at least one network node in response to the service request, the service running information to the service quality processing node during running of the test service includes: adding, by the at least one network node, the service running information to service message of the test service, and sending the service running information to the service quality processing node by using the interface between the one network node of the at least one network node and the service quality processing node or the interface between the service request initiation device and the service quality processing node; or when the test indication information is the second test identifier, the sending, by the at least one network node in response to the service request, the service running information to the service quality processing node during running of the test service includes: sending, by each of the at least one network node, the service running information to the service quality processing node by using the interface between each of the at least one network node and the service quality processing node.

In another implementation manner of this embodiment, the test indication information includes: a network node type. Further, the sending, by the at least one network node in response to the service request, the service running information to the service quality processing node during running of the test service includes: determining, by the at least one network node, whether a network node type of the at least one network node is the same as the network node type in the test indication information; and sending, by a network node of the at least one network node whose network node type is the same as the network node type indicated by the test indication information during running of the test service, the service running information to the service quality processing node.

In another implementation manner of this embodiment, the test indication information includes: a service message type. Further, the sending, by the at least one network node in response to the service request, the service running information to the service quality processing node during running of the test service includes: sending, by the at least one network node, the service running information corresponding to the service message type to the service quality processing node, where the service running information corresponding to the service message type includes a time point at which a service message of the service message type arrives at the at least one network node.

According to another aspect, an embodiment further provides a service testing method. The method includes: receiving, by a service quality processing node, service running information of a test service, where the service running information includes a time point at which a service message of the test service arrives at at least one network node. The method also includes determining, by the service quality processing node according to the service running information, the time point at which the service message of the test service arrives at the at least one network node. The method also includes calculating, by the service quality processing node, a time length between two adjacent time points that are recorded in the service running information, or calculating a time length between one time point that is recorded in the service running information and a time point at which the service message is sent from a service request initiation device or between one time point that is recorded in the service running information and a time point at which the service message arrives at a server. The method also includes comparing, by the service quality processing node, the calculated time length with a corresponding preset time length, where the corresponding preset time length refers to a preset time length between two network nodes corresponding to the two adjacent time points, or a preset time length between one network node corresponding to the one time point and a service request initiation device. The method also includes, when the calculated time length is greater than the corresponding preset time length, determining, by the service quality processing node, that a network exception exists between the two network nodes corresponding to the two adjacent time points, or between the one network node corresponding to the one time point and the service request initiation device or the server.

In an implementation manner of this embodiment, the comparing the calculated time length with a corresponding preset time length includes: determining, by the service quality processing node according to a service type, a preset time length corresponding to the service type; and comparing, by the service quality processing node, the calculated time length with the corresponding preset time length, where the corresponding preset time length refers to the preset time length that corresponds to the service type and that is between the two network nodes corresponding to the two adjacent time points, or a preset time length that corresponds to the service type and that is between the one network node corresponding to the one time point and the service request initiation device.

According to another aspect, an embodiment further provides a service request initiation device. The device includes: a processor, configured to generate a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node. The device also includes a transmitter, configured to send the service request.

In an implementation manner of this embodiment, the test indication information includes a first test identifier or a second test identifier. The first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node. The second test identifier is used to instruct each of the at least one network node to send the service running information to the service quality processing node by using an interface between each of the at least one network node and the service quality processing node.

In another implementation manner of this embodiment, the test indication information includes: a network node type, where the network node type is used to instruct the at least one network node corresponding to the network node type to send the service running information to the service quality processing node.

In another implementation manner of this embodiment, the test indication information includes: a service message type, where the service message type is used to instruct the at least one network node to send the service running information corresponding to the service message type to the service quality processing node, and the service running information corresponding to the service message type includes a time point at which a service message of the service message type arrives at the at least one network node.

According to another aspect, an embodiment further provides a network node. The network node includes: a receiver, configured to receive a service request of a test service, where the service request includes test indication information, the test indication information is used to instruct at least one network node to send service running information of the test service to a service quality processing node, and the service running information includes a time point at which a service message of the test service arrives at the at least one network node or a time point at which a service message of the test service is sent by the at least one network node. The network node also includes a processor, configured to send, in response to the service request, the service running information to the service quality processing node during running of the test service.

In an implementation manner of this embodiment, the test indication information includes a first test identifier or a second test identifier, where the processor is configured to: when the test indication information is the first test identifier, add the service running information to service message of the test service, and send the service running information to the service quality processing node by using an interface between the network node and the service quality processing node or an interface between a service request initiation device and the service quality processing node; or when the test indication information is the second test identifier, send the service running information to the service quality processing node by using an interface between each of the at least one network node and the service quality processing node.

In another implementation manner of this embodiment, the test indication information includes: a network node type, and the processor is configured to: determine whether a network node type of the processor is the same as the network node type in the test indication information; and when determining that the network node type of the processor is the same as the network node type in the test indication information, send the service running information to the service quality processing node during running of the test service.

In another implementation manner of this embodiment, the test indication information includes: a service message type, where the processor is configured to send the service running information corresponding to the service message type to the service quality processing node, and the service running information corresponding to the service message type includes a time point at which a service message of the service message type arrives at the at least one network node.

According to another aspect, an embodiment further provides a service quality processing node. The node includes: a receiver, configured to receive service running information of a test service, where the service running information includes a time point at which a service message of the test service arrives at at least one network node. The node also includes a processor, configured to: determine, according to the service running information, the time point at which the service message of the test service arrives at the at least one network node; calculate a time length between two adjacent time points that are recorded in the service running information, or calculate a time length between one time point that is recorded in the service running information and a time point at which the service message is sent from a service request initiation device or between one time point that is recorded in the service running information and a time point at which the service message arrives at a server; compare the calculated time length with a corresponding preset time length, where the corresponding preset time length refers to a preset time length between two network nodes corresponding to the two adjacent time points, or a preset time length between one network node corresponding to the one time point and a service request initiation device; and when the calculated time length is greater than the corresponding preset time length, determine that a network exception exists between the two network nodes corresponding to the two adjacent time points, or between the one network node corresponding to the one time point and the service request initiation device or the server.

In an implementation manner of this embodiment, the processor includes: a determining unit, configured to determine, according to a service type, a preset time length corresponding to the service type. The processor also includes a comparison unit, configured to compare the calculated time length with the corresponding preset time length, where the corresponding preset time length refers to the preset time length that corresponds to the service type and that is between the two network nodes corresponding to the two adjacent time points, or a preset time length that corresponds to the service type and that is between the one network node corresponding to the one time point and the service request initiation device.

According to another aspect, an embodiment further provides a service testing system. The system includes: the service request initiation device described in any above item, the network node described in any above item, and the service quality processing node described in any above item.

Beneficial effects of the technical solutions provided by the embodiments are as follows.

A service request initiation device sends a service request of a test service, where the service request includes test indication information, and the test indication information is used to instruct an intermediate network node that receives the service request to send a time point at which a service message of the test service arrives at the intermediate network node to a service quality processing node. Therefore, the service quality processing node can obtain a time point at which the service message of the test service arrives at at least one network node, thereby obtaining a detailed service running status, and achieving a more precise service test result that is more beneficial for network exception identification.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is an architectural diagram of a system according to an embodiment;

FIG. 2 is a flowchart of a service testing method according to Embodiment 1;

FIG. 3 is a flowchart of a service testing method according to Embodiment 2;

FIG. 4 is a flowchart of a service testing method according to Embodiment 3;

FIG. 5 is a flowchart of a service testing method according to Embodiment 4;

FIG. 6 is a flowchart of a service testing method according to Embodiment 5;

FIG. 7 is a flowchart of a service testing method according to Embodiment 6;

FIG. 8 is a flowchart of a service testing method according to Embodiment 7;

FIG. 9 is a flowchart of a service test method according to Embodiment 8;

FIG. 10 is a schematic diagram of a structure of a service request initiation device according to Embodiment 9;

FIG. 11 is a schematic diagram of a structure of a service request initiation device according to Embodiment 10;

FIG. 12 is a schematic diagram of a structure of a network node according to Embodiment 11;

FIG. 13 is a schematic diagram of a structure of a network node according to Embodiment 12;

FIG. 14 is a schematic diagram of a structure of a service quality processing node according to Embodiment 13;

FIG. 15 is a schematic diagram of a structure of a service quality processing node according to Embodiment 14; and

FIG. 16 is a schematic diagram of a structure of a service testing system according to Embodiment 15.

### DETAILED DESCRIPTION OF ILLUSTRATIVE EMBODIMENTS

To make the objectives, technical solutions, and advantages of the present invention clearer, the following further describes the embodiments of the present invention in detail with reference to the accompanying drawings.

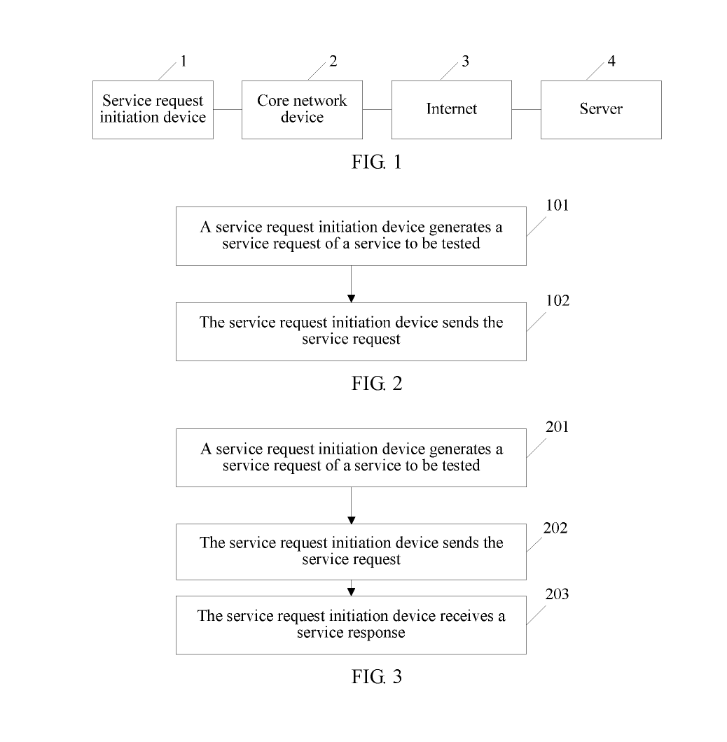

The following describes a possible system architecture involved in the method provided in this embodiment of the present invention. As shown in FIG. 1, a service request initiation device 1 is connected to a server 4 (which is mainly configured to provide service content, for example, a multimedia service) by using a core network device (“CN” for short) 2 and the Internet 3, where the service request initiation device 1 may be a base station, for example, an evolved NodeB (“eNB” for short), or a radio network controller (“RNC” for short); a base station and user equipment; or the CN device 2, where the CN device 2 includes network nodes such as a mobility management entity (“MME” for short) and a gateway (“GW” for short). For a service provided by an operator, for example, a short message service or a voice service, the Internet 3 and the server 4 may be not used. Therefore, for the system architecture, the Internet 3 and the server 4 are optional. The server 4 is configured to provide, to the service request initiation device, a service acknowledge or service content All servers mentioned below have a function that is the same as or similar to that of the server 4.

During network communication, a service is usually initiated by user equipment; therefore, during a service test, for the purpose of not affecting a processing procedure on an existing network, when the service request initiation device is not user equipment, the service request initiation device may simulate a service initiation function of the user equipment, to initiate a test service. The service request initiation device may initiate different types of services according to different service formats defined in an existing standard.

### Embodiment 1

An embodiment provides a service testing method, where the method is executed by a service request initiation device, and the service request initiation device may be an eNB, user equipment, or a core network device. Referring to FIG. 2, the method includes the following steps.

Step 101: A service request initiation device generates a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node.

The service message of the test service includes all or some messages that are used to implement running of the test service and that are exchanged by at least one network node during running of the test service, and may specifically include messages such as a service request of the test service, a user access response, and a response to a service request. Service types of different test services are different, and all or some service messages of a test service may be different from each other. A person skilled in the art may determine service messages of different test services by referring to the prior art.

Optionally, before generating the service request of the test service, the service request initiation device may receive a test policy that is delivered by a network management system, for example, an operation, administration and maintenance (“OAM” for short) system, by using a northbound interface or a southbound interface, where the test policy includes a service type of the test service, a service format, an initiation condition of the test service, or the like. The initiation condition of the test service may be that the service request initiation device is instructed to periodically initiate a service request; or may be that a service request is initiated in a manner of event triggering, for example, signal quality of user equipment deteriorates to be less than a threshold, or a network architecture is redeployed because a network node is added, deleted, or moved in the network architecture. The test policy may not need to be delivered by the OAM system, and may be preset by the service request initiation device. There may be many test policies, and are not described one by one herein.

Further, the service request further includes the following fields: a service type and a user equipment identity (“UE ID” for short). When the service request initiation device is user equipment, the user equipment may initiate a test service according to an existing service initiation procedure. Optionally, to ensure accuracy of a service test, when a service test is performed by using a base station or another non-UE device, a UE ID may be generated in a manner such as using software, to initiate the test service.

Optionally, the service request may further include a destination address of a server, where the destination address is used to indicate from which service content provider service content is obtained. The destination address of the server may be a URL. The service type includes, but is not limited to, video, e-mail, download, and a web page. The UE ID may be an International Mobile Equipment Identity (“IMEI” for short) or an International Mobile Subscriber Identification Number (“IMSI” for short).

When the UE ID is set to an IMEI, the service request initiation device is equivalent to user equipment in which no subscriber identity module (“SIM” for short) card is inserted, and in this case, the service request initiation device can initiate only an emergency call service. When the UE ID is set to an IMSI, the service request initiation device may initiate any type of service.

When the UE ID is set to an IMEI, the server does not need to authenticate the UE ID. When the UE ID is set to an IMSI, the server needs to authenticate the UE ID. If the authentication does not succeed, the server does not process a request from the service request initiation device. If the authentication succeeds, the server processes a request from the service request initiation device.

In specific implementation, the test indication information may be implemented by adding a field to an existing service request.

Step 102: The service request initiation device sends the service request.

As a specific example, it is assumed that the service request initiation device is UE, the at least one network node includes a base station and a core network device, and the service quality processing node is a network management system. When the initiation condition of the test service is met, the UE sends an initial direct transfer (INITIAL DIRECT TRANSFER) message to the base station by using an established radio resource control (“RRC” for short) connection to the base station, where the initial direct transfer message includes a call management service request (CM SERVICE REQUEST). The base station receives the initial direct transfer message, and records a time point at which the initial direct transfer message arrives. The base station sends an initial UE message (INITIAL UE MESSAGE) to the core network device by using an S1 interface or an Iu interface, where the message includes the call management service request, and the base station records a time point at which the initial UE message is sent. The core network device receives the initial UE message, and records a time point at which the initial UE message arrives. The core network device sends a response message to the UE by using the base station, and records a time point at which the response message is sent. In this specific example, a type of the test service is a call management service, and a service message of the test service includes at least an initial direct transfer message, an initial UE message, and a response message. The base station and the core network device may send, to the network management system by using a northbound interface or a southbound interface, a recorded time point at which a service message of a test service arrives and a recorded time point at which the service message of the test service is sent, so that the network management system determines whether an exception occurs on a network.

In this embodiment, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and is more beneficial for network exception identification.

### Embodiment 2

An embodiment provides a service testing method, where the method is executed by a service request initiation device, and the service request initiation device may be an eNB or user equipment. Referring to FIG. 3, the method includes the following steps.

Step 201: A service request initiation device generates a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node.

Further, the service request further includes the following fields: a destination address of a server, a service type, and a UE ID. To ensure accuracy of a service test, even when a service test is performed by using a base station or another non-UE device, a UE ID may be generated in a manner such as using software.

The destination address may be a URL. The service type includes, but is not limited to, video, e-mail, download, and a web page. The UE ID may be an IMEI or an IMSI.

When the UE ID is set to an IMEI, the service request initiation device is equivalent to user equipment in which no SIM card is inserted, and in this case, the service request initiation device can initiate only an emergency call service. When the UE ID is set to an IMSI, the service request initiation device may initiate any type of service.

When the UE ID is set to an IMEI, the server does not need to authenticate the UE ID. When the UE ID is set to an IMSI, the server needs to authenticate the UE ID. If the authentication does not succeed, the server does not process a request from the service request initiation device. If the authentication succeeds, the server processes a request from the service request initiation device. The server is configured to provide a service response or a service to the service request initiation device.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

Further, the test indication information may further instruct the at least one network node during running of the test service to send a transmission correctness percentage of service message to the service quality processing node. Certainly, in another implementation manner of this embodiment of the present invention, the service running information may further include common information in another service test, and details are not described herein again.

In an implementation manner of this embodiment, the test indication information includes a first test identifier or a second test identifier. The first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node; and the second test identifier is used to instruct each of the at least one network node to send the service running information to the service quality processing node by using an interface between each of the at least one network node and the service quality processing node.

As a specific example, it is assumed that the service request initiation device is UE, the at least one network node includes a base station and a core network device, and the service quality processing node is a network management system. When an initiation condition of the test service is met, the UE sends an initial direct transfer message to the base station by using an established RRC connection to the base station, where the initial direct transfer message includes a call management service request. The base station receives the initial direct transfer message, and records a time point at which the initial direct transfer message arrives. The base station sends an initial UE message to the core network device by using an S1 interface or an Iu interface, where the message includes the call management service request, and the base station records a time point at which the initial UE message is sent. The core network device receives the initial UE message, and records a time point at which the initial UE message arrives. The core network device sends a response message to the UE by using the base station, and records a time point at which the response message is sent. In this specific example, a type of the test service is a call management service, and a service message of the test service includes at least an initial direct transfer message, an initial UE message, and a response message. The base station and the core network device may send, to the network management system by using a northbound interface or a southbound interface, a recorded time point at which a service message of a test service arrives and a recorded time point at which the service message of the test service is sent, so that the network management system determines whether an exception occurs on a network.

In another implementation manner of this embodiment, the test indication information includes: a network node type, where the network node type is used to instruct the at least one network node corresponding to the network node type to send the service running information to the service quality processing node.

Certainly, it is indicated by using test indication information that which network nodes send service running information; in addition, it may be defined in advance which network nodes send service running information, for example, it is stipulated in a protocol, it is directly set on a network node, or the like. As for whether a network node is enabled to send service running information, an actual need of a service test is considered, and in addition, a processing capability of the network node needs to be considered; for example, a network node that does not support the function is not required to send the service running information.

In another implementation manner of this embodiment, the test indication information includes: a service message type, where the service message type is used to instruct the at least one network node to send the service running information corresponding to the service message type to the service quality processing node, and the service running information corresponding to the service message type includes a time point at which a service message of the service message type arrives at the at least one network node.

The service message refers to all messages during service running, and the service request is only one type of service message. For example, a video service not only includes a video data packet, but also includes a playback monitoring and control message; each service message may have one identifier, where the identifier is used to indicate the service message type.

Step 202: The service request initiation device sends the service request.

Step 203: The service request initiation device receives a service response, where the service response is generated according to the service request after the server receives a service request. The network node mentioned in the foregoing step in this embodiment includes an intermediate network node, and also includes the server described herein.

In this embodiment of the present invention, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and is more beneficial for network exception identification.

### Embodiment 3

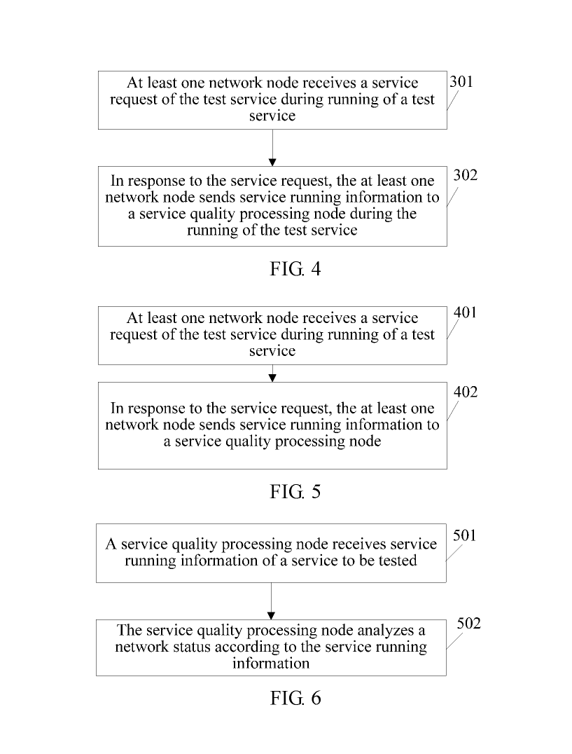

An embodiment of the present invention provides a service testing method, where the method is executed by a network node. Referring to FIG. 4, the method includes the following steps.

Step 301: At least one network node during running of a test service receives a service request of the test service, where the service request includes test indication information, the test indication information is used to instruct the at least one network node to send service running information of the test service to a service quality processing node, and the service running information includes a time point at which a service message of the test service arrives at the at least one network node or a time point at which a service message of the test service is sent by the at least one network node.

Further, the service request further includes the following fields: a destination address of a server, a service type, and a UE ID, where the destination address may be a URL. The service type includes, but is not limited to, video, e-mail, download, and a web page. The UE ID may be an IMEI or an IMSI.

Step 302: In response to the service request, the at least one network node sends the service running information to the service quality processing node during running of the test service.

Before sending the service running information, the network node monitors the received information, and records a time point at which the service request arrives.

It should be noted that, the network node includes an intermediate network node and a server, and multiple intermediate network nodes may exist between a service request initiation device and the server, where each intermediate network node performs steps 301 and 302. The server is configured to provide a service response or a service to the service request initiation device.

In this embodiment, when receiving a service request of a test service, a network node sends service running information to a service quality processing node, where the service running information includes a time point at which a service message of the test service arrives at at least one network node or a time point at which a service message of the test service is sent by at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 4

An embodiment provides a service testing method, where the method is executed by a network node. Referring to FIG. 5, the method includes the following steps.

Step 401: At least one network node receives a service request of the test service during running of a test service, where the service request includes test indication information, the test indication information is used to instruct the at least one network node to send service running information of the test service to a service quality processing node, and the service running information includes a time point at which a service message of the test service arrives at the at least one network node or a time point at which a service message of the test service is sent by the at least one network node.

Further, the service request further includes the following fields: a destination address of a server, a service type, and a UE ID, where the destination address may be a URL. The service type includes, but is not limited to, video, e-mail, download, and a web page. The UE ID may be an IMEI or an IMSI.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

Step 402: In response to the service request, the at least one network node sends the service running information to the service quality processing node.

Specifically, the network node in this embodiment may be an intermediate network node, or may be a server. The server is configured to provide a service response or a service to the service request initiation device.

In an implementation manner of this embodiment, the test indication information includes a first test identifier or a second test identifier, where the first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node; and the second test identifier is used to instruct each of the at least one network node to send the service running information to the service quality processing node by using an interface between each of the at least one network node and the service quality processing node.

As a specific example, it is assumed that the service request initiation device is UE, the at least one network node includes a base station and a core network device, and the service quality processing node is a network management system. When an initiation condition of the test service is met, the UE sends an initial direct transfer message to the base station by using an established RRC connection to the base station, where the initial direct transfer message includes a call management service request. The base station receives the initial direct transfer message, and records a time point at which the initial direct transfer message arrives. The base station sends an initial UE message to the core network device by using an S1 interface or an Iu interface, where the message includes the call management service request, and the base station records a time point at which the initial UE message is sent. The core network device receives the initial UE message, and records a time point at which the initial UE message arrives. The core network device sends a response message to the UE by using the base station, and records a time point at which the response message is sent. In this specific example, a type of the test service is a call management service, and a service message of the test service includes at least an initial direct transfer message, an initial UE message, and a response message. The base station and the core network device may send, to the network management system by using a northbound interface or a southbound interface, a recorded time point at which a service message of a test service arrives and a recorded time point at which the service message of the test service is sent, so that the network management system determines whether an exception occurs on a network.

When the test indication information is the first test identifier, step 402 may be implemented in the following manner: adding, by the at least one network node, the service running information to service message of the test service, and sending the service running information to the service quality processing node by using the interface between the one network node of the at least one network node and the service quality processing node or the interface between the service request initiation device and the service quality processing node.

When the test indication information is the second test identifier, step 402 may be implemented in the following manner: sending, by each of the at least one network node, the service running information to the service quality processing node by using the interface between each of the at least one network node and the service quality processing node.

In another implementation manner of this embodiment, the test indication information includes: a network node type; and step 402 may be implemented in the following manner: determining, by the at least one network node, whether a network node type of the at least one network node is the same as the network node type in the test indication information; and sending, by a network node of the at least one network node whose network node type is the same as the network node type indicated by the test indication information during running of the test service, the service running information to the service quality processing node.

In another implementation manner of this embodiment, the test indication information includes: a service message type, and step 402 may be implemented in the following manner: sending, by the at least one network node, the service running information corresponding to the service message type to the service quality processing node, where the service running information corresponding to the service message type includes a time point at which a service message of the service message type arrives at the at least one network node.

The service message refers to all messages during service running, and the service request is one type of service message. For example, a video service not only includes a video data packet, but also includes a monitoring playback control message; each service message has one identifier, where the identifier is used to indicate the service message type.

Certainly, in another implementation manner of this embodiment, the service running information may further include common information in another service test, and details are not described herein again.

In addition, besides performing the foregoing steps, the network node further needs to perform another function. For example, the base station schedules a radio resource, or the core network performs processing in aspects such as authentication and routing.

In this embodiment, when receiving a service request of a test service, a network node sends service running information to a service quality processing node, where the service running information includes a time point at which a service message of the test service arrives at at least one network node or a time point at which a service message of the test service is sent by at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 5

An embodiment provides a service testing method, where the method is executed by a service quality processing node. Referring to FIG. 6, the method includes the following steps.

Step 501: A service quality processing node receives service running information of a test service, where the service running information includes a time point at which a service message of the test service arrives at at least one network node or a time point at which a service message of the test service is sent by at least one network node.

Step 502: The service quality processing node analyzes a network status according to the service running information.

Specifically, step 502 may be implemented in the following manner: determining the time point at which the service message of the test service arrives at the at least one network node; calculating a time length between two adjacent time points that are recorded in the service running information, or calculating a time length between one time point that is recorded in the service running information and a time point at which the service message is sent from a service request initiation device or between one time point that is recorded in the service running information and a time point at which the service message arrives at a server; comparing the calculated time length with a corresponding preset time length, where the corresponding preset time length refers to a preset time length between two network nodes corresponding to the two adjacent time points, or a preset time length between one network node corresponding to the one time point and a service request initiation device; and when the calculated time length is greater than the corresponding preset time length, determining that a network exception exists between the two network nodes corresponding to the two adjacent time points, or between the one network node corresponding to the one time point and the service request initiation device.

In this embodiment, service running information of a test service is received, where the service running information includes a time point at which a service message of the test service arrives at at least one network node or a time point at which a service message of the test service is sent by at least one network node. Therefore, the time point at which the service message of the test service arrives at the at least one network node is obtained, which avoids a problem in the prior art that only a time point at which service message is initiated and a time point at which the service message arrives can be obtained in a manual dialing test. Service test result are more comprehensive, and are more beneficial for network exception identification.

### Embodiment 6

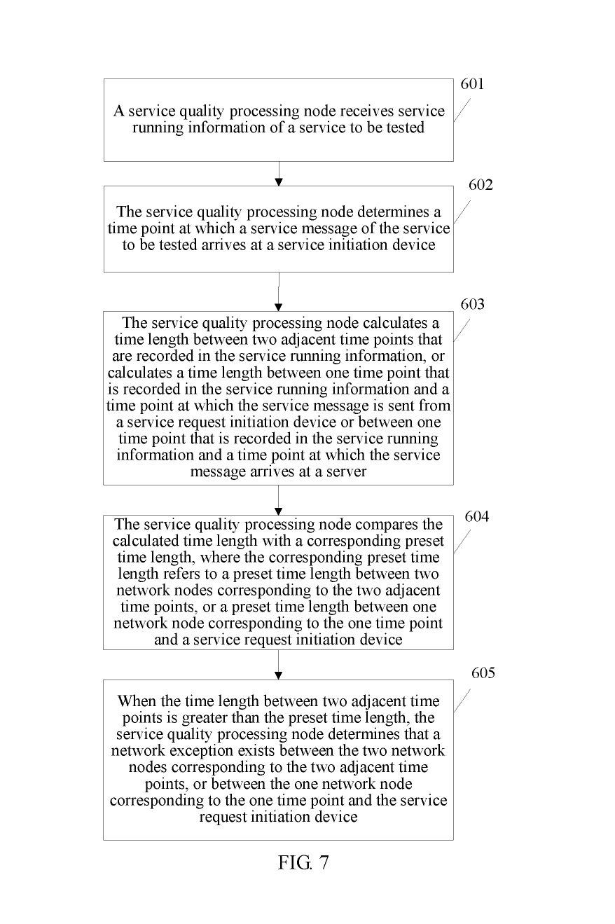

An embodiment provides a service testing method, where the method is executed by a service quality processing node. Referring to FIG. 7, the method includes the following steps.

Step 601: A service quality processing node receives service running information of a test service, where the service running information includes a time point at which a service message of the test service arrives at at least one network node or a time point at which a service message of the test service is sent by at least one network node.

Step 602: The service quality processing node determines the time point at which the service message of the test service arrives at the at least one network node.

Step 603: The service quality processing node calculates a time length between two adjacent time points that are recorded in the service running information, or calculates a time length between one time point that is recorded in the service running information and a time point at which the service message is sent from a service request initiation device or between one time point that is recorded in the service running information and a time point at which the service message arrives at a server.

A start time of a service message refers to a time point at which the service message is sent from the service request initiation device or the server, and an arrival time refers to a time point at which the service message arrives at the server or the service request initiation device.

Step 604: The service quality processing node compares the calculated time length with a corresponding preset time length, where the corresponding preset time length refers to a preset time length between two network nodes corresponding to the two adjacent time points, or a preset time length between one network node corresponding to the one time point and a service request initiation device.

Specifically, step 604 may be implemented in the following manner.

Step 1: The service quality processing node determines, according to a service type, a preset time length corresponding to the service type.

The preset time length varies according to different service types, for example, between two same network nodes, a preset time length corresponding to a video service is greater than a preset time length corresponding to an e-mail service.

Step 2: The service quality processing node compares the calculated time length with the corresponding preset time length, where the corresponding preset time length refers to a preset time length that corresponds to the service type and that is between the two network nodes corresponding to the two adjacent time points, or a preset time length that corresponds to the service type and that is between the one network node corresponding to the one time point and the service request initiation device.

Step 605: When the calculated time length is greater than the corresponding preset time length, the service quality processing node determines that a network exception exists between the two network nodes corresponding to the two adjacent time points, or between the one network node corresponding to the one time point and the service request initiation device.

Certainly, in another embodiment, a network status may be further analyzed in another manner.

For the convenience of understanding, the following gives an example of the method provided in this embodiment: for example, two network nodes A and B exist between the service request initiation device and the server, a preset time length of a video service between A and B is 100 ms, and a preset time length of an e-mail service is 50 ms. Therefore, when the service quality processing node receives service running information of a test service, if the service running information includes a time point at which a service message arrives at A and a time point at which the service message arrives at B, and the time point at which the service message arrives at A and the time point at which the service message arrives at B are adjacent time points, the following processing is performed: a time length between A and B is calculated; a service type is determined, and if in this case, the service type is a video service, it may be obtained that the preset time length is 100 ms; and the calculated time length is compared with 100 ms, and when the calculated time length is greater than 100 ms, it is determined that a network fault exists between A and B.

In this embodiment, service running information of a test service is received, where the service running information includes a time point at which a service message of the test service arrives at at least one network node or a time point at which a service message of the test service is sent by at least one network node. Therefore, the time point at which the service message of the test service arrives at the at least one network node is obtained, which avoids a problem in the prior art that only a time point at which service message is initiated and a time point at which the service message arrives can be obtained in a manual dialing test. Service test results are more comprehensive, and are more beneficial for network exception identification.

### Embodiment 7

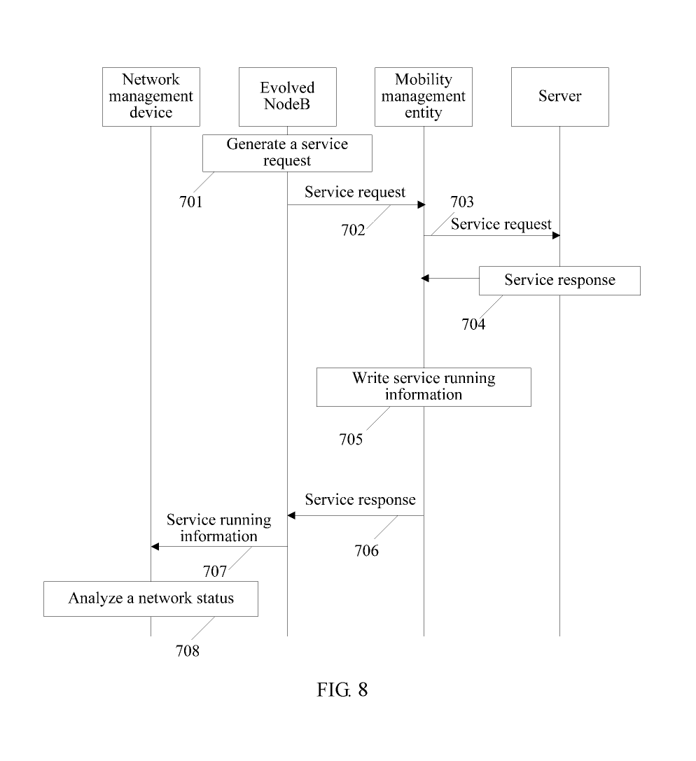

An embodiment provides a service testing method. In this embodiment, service running information is a time point at which a service response arrives at an intermediate network node, test indication information is a first test identifier, a service request initiation device is an eNB, network nodes include the intermediate network node and a server, the intermediate network node is an MME, and a service quality processing node is a network management device. Referring to FIG. 8, the method includes the following steps.

Step 701: A service request initiation device generates a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node.

The service request initiation device may be an e-NB or user equipment.

The service request further includes: a destination address, a service type, and a UE ID. Specifically, the destination address may be a URL. The service type includes, but is not limited to, video, e-mail, download, and a web page. The UE ID may be an IMEI or an IMSI.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

In this embodiment, the test indication information instructs an intermediate network node to send the time point at which the service response arrives to the service quality processing node.

Step 702: The service request initiation device sends the service request.

Step 703: After receiving the service request of the test service, an intermediate network node processes and forwards the service request.

After processing the received service request, the intermediate network node forwards the received service request to a next network node, where the processing may be the following content: a base station processes a radio resource, and a core network performs processing in aspects such as authentication and routing.

Step 704: A server generates a service response according to the service request, and sends the service response.

The server is configured to provide a service response or a service to the service request initiation device.

Step 705: The intermediate network node receives the service response, and adds the service running information to the service response, where the service running information includes a time point at which the service response arrives.

Step 706: The intermediate network node processes and forwards the service response.

Step 707: The service request initiation device receives the service response, acquires service running information in the service response, and sends the service running information to the service quality processing node.

In another implementation manner of this embodiment of the present invention, the service request initiation device may further directly send the service response to the service quality processing node.

Step 708: The service quality processing node analyzes a network status according to the service running information.

For the convenience of understanding, the following gives an example of the method provided in this embodiment: for example, two network nodes A and B exist between the service request initiation device and the server, a preset time length of a video service between A and B is 100 ms, and a preset time length of an e-mail service is 50 ms. Therefore, when the service quality processing node receives service running information of a test service, if the service running information includes a time point at which a service message arrives at A and a time point at which the service message arrives at B, and the time point at which the service message arrives at A and the time point at which the service message arrives at B are adjacent time points, the following processing is performed: a time length between A and B is calculated; a service type is determined, and if in this case, the service type is a video service, it may be obtained that the preset time length is 100 ms; and the calculated time length is compared with 100 ms, and when the calculated time length is greater than 100 ms, it is determined that a network fault exists between A and B.

In step 708, an automatic service testing method is adopted, thereby avoiding a problem of manual involvement and high labor consumption in a conventional network test.

It is easy to know that, the analysis of the network status may also be implemented manually.

In another implementation manner of this embodiment of the present invention, the service quality processing node may be the service request initiation device, and in this case, after receiving a service response, the service request initiation device acquires service running information in the service response, and analyzes the network status according to the service running information.

In this embodiment, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node; and the network node adds the service running information to service message of the test service. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 8

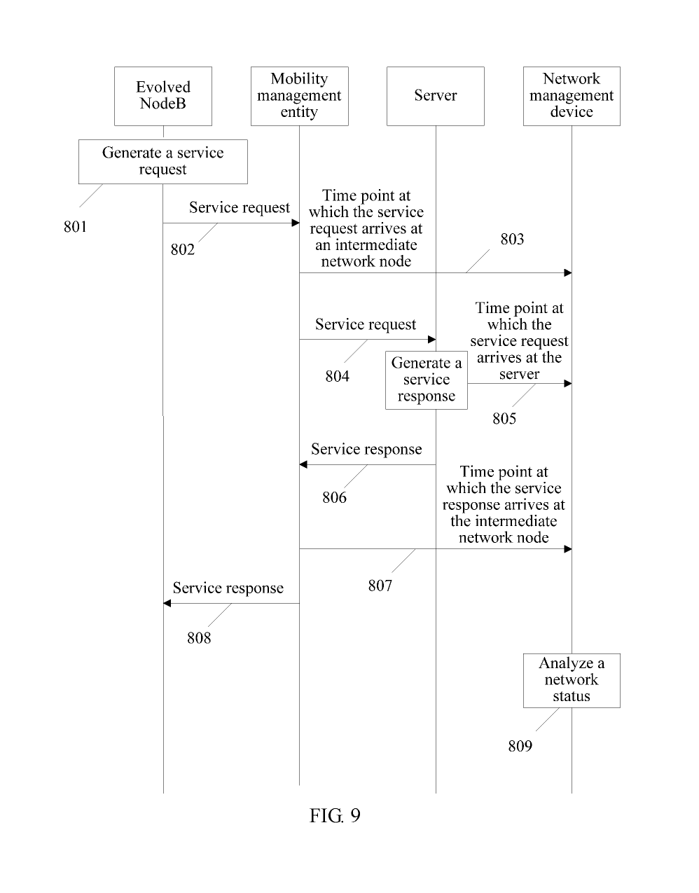

An embodiment provides a service testing method. In this embodiment, service running information is a time point at which a service request arrives at a network node and a time point at which a service response arrives at a network node, test indication information is a second test identifier, a service request initiation device is an eNB, network nodes include an intermediate network node and a server, the intermediate network node is an MME, and a service quality processing node is a network management device, for example, an OAM system. Referring to FIG. 9, the method includes the following steps.

Step 801: A service request initiation device generates a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node.

The service request initiation device may be an e-NB or user equipment.

The service request further includes: a destination address, a service type, and a UE ID. Specifically, the destination address may be a URL. The service type includes, but is not limited to, video, e-mail, download, and a web page. The UE ID may be an IMEI or an IMSI.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

In this embodiment, besides instructing an intermediate network node and a server to send the time point at which the service request arrives to the service quality processing node, the test indication information further instructs the intermediate network node to send the time point at which the service response arrives to the service quality processing node. The server is configured to provide a service response or a service to the service request initiation device.

Step 802: The service request initiation device sends the service request.

Step 803: An intermediate network node receives a service request of the test service, and directly sends a time point at which the service request arrives at the intermediate network node to the service quality processing node.

Step 804: The intermediate network node processes and forwards the service request.

After processing the received service request, the intermediate network node forwards the received service request to a next network node, where the processing may be the following content: a base station processes a radio resource, and a core network performs processing in aspects such as authentication and routing.

Step 805: A server generates a service response according to the service request, and sends the time point at which the service request arrives to the service quality processing node.

Step 806: The server sends the service response.

Step 807: The intermediate network node receives the service response, and directly sends a time point at which the service response arrives at the intermediate network node to the service quality processing node.

Step 808: The intermediate network node sends the service response to the service request initiation device.

Step 809: The service quality processing node analyzes a network status according to the time point at which the service request arrives at the intermediate network node, the time point at which the service request arrives at the server, and the time point at which the service response arrives at the intermediate network node.

For the convenience of understanding, the following gives an example of the method provided in this embodiment: for example, two network nodes A and B exist between the service request initiation device and the server, a preset time length of a video service between A and B is 100 ms, and a preset time length of an e-mail service is 50 ms. Therefore, when the service quality processing node receives service running information of a test service, if the service running information includes a time point at which a service message arrives at A and a time point at which the service message arrives at B, and the time point at which the service message arrives at A and the time point at which the service message arrives at B are adjacent time points, the following processing is performed: a time length between A and B is calculated; a service type is determined, and if in this case, the service type is a video service, it may be obtained that the preset time length is 100 ms; and the calculated time length is compared with 100 ms, and when the calculated time length is greater than 100 ms, it is determined that a network fault exists between A and B.

In step 809, an automatic service testing method is adopted, thereby avoiding a problem of manual involvement and high labor consumption in a conventional network test.

It is easy to know that, the analysis of the network status may also be implemented manually.

In this embodiment, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node; and the network node directly sends the service running information to the service request initiation device. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test result are more comprehensive, and are more beneficial for network exception identification.

### Embodiment 9

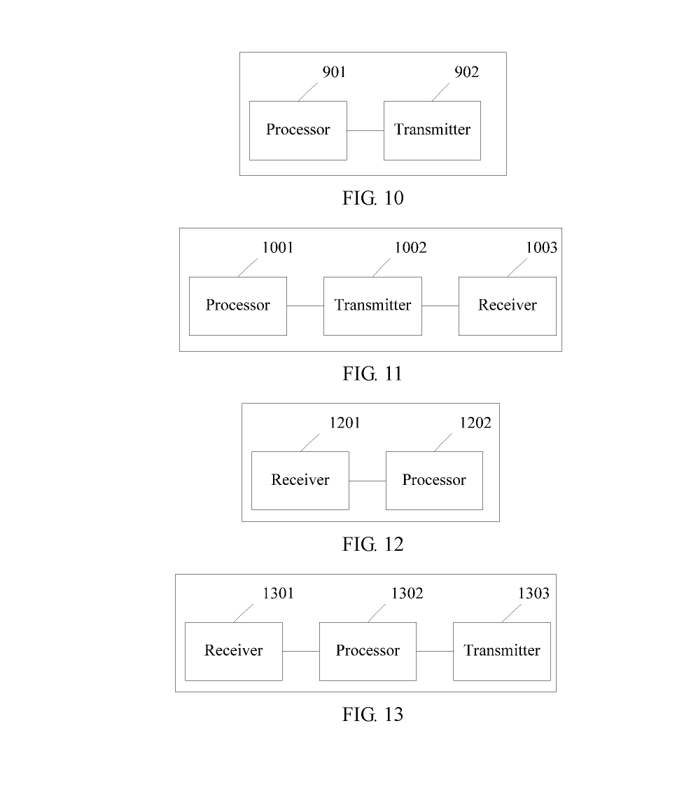

An embodiment provides a service request initiation device. Referring to FIG. 10, the service request initiation device includes: a processor 901, configured to generate a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node; and a transmitter 902, configured to send the service request.

In this embodiment, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 10

An embodiment provides a service request initiation device, where the service request initiation device may be an eNB or user equipment. Referring to FIG. 1i, the service request initiation device includes: a processor 1001, a transmitter 1002, and a receiver 1003.

The processor 1001 is configured to generate a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node. The transmitter 1002 is configured to send the service request, and the receiver 1003 is configured to receive a service response, where the service response is generated according to the service request after a server receives the service request. The network node mentioned in the foregoing step in this embodiment includes an intermediate network node, and also includes the server described herein.

The server is configured to provide a service response or a service to the service request initiation device.

Further, the service request further includes the following fields: a destination address of a server, a service type, and a UE ID. To ensure accuracy of a service test, even when a service test is performed by using a base station or another non-UE device, a UE ID may be generated in a manner such as using software.

The destination address may be a URL. The service type includes, but is not limited to, video, e-mail, download, and a web page. The UE ID may be an IMEI or an IMSI.

When the UE ID is set to an IMEI, the service request initiation device is equivalent to user equipment in which no SIM card is inserted, and in this case, the service request initiation device can initiate only an emergency call service. When the UE ID is set to an IMSI, the service request initiation device may initiate any type of service.

When the UE ID is set to an IMEI, the server does not need to authenticate the UE ID. When the UE ID is set to an IMSI, the server needs to authenticate the UE ID. If the authentication does not succeed, the server does not process a request from the service request initiation device. If the authentication succeeds, the server processes a request from the service request initiation device.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

Further, the test indication information includes a first test identifier or a second test identifier, where the first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node; and the second test identifier is used to instruct each of the at least one network node to send the service running information to the service quality processing node by using an interface between each of the at least one network node and the service quality processing node.

Further, the test indication information includes: a network node type, where the network node type is used to instruct the at least one network node corresponding to the network node type to send the service running information to the service quality processing node.

Certainly, it is indicated by using test indication information that which network nodes send service running information; in addition, it may be defined in advance which network nodes send service running information, for example, it is stipulated in a protocol, it is directly set on a network node, or the like. As for whether a network node is enabled to send service running information, an actual need of a service test is considered, and in addition, a processing capability of the network node needs to be considered; for example, a network node that does not support the function is not required to send the service running information.

Further, the test indication information includes: a service message type, where the service message type is used to instruct the at least one network node to send the service running information corresponding to the service message type to the service quality processing node, and the service running information corresponding to the service message type includes a time point at which a service message of the service message type arrives at the at least one network node.

The service message refers to all messages during service running, and the service request is one type of service message. For example, a video service not only includes a video data packet, but also includes a monitoring playback control message; each service message has one identifier, where the identifier is used to indicate the service message type.

In this embodiment of the present invention, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 11

An embodiment provides a network node. Referring to FIG. 12, the network node includes: a receiver 1201, configured to receive a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node. The network node also includes a processor 1202, configured to send, in response to the service request, the service running information to the service quality processing node during running of the test service.

In this embodiment, when receiving a service request of a test service, a network node sends service running information to a service quality processing node, where the service running information includes a time point at which a service message of the test service arrives at at least one network node or a time point at which a service message of the test service is sent by at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test result are more comprehensive, and are more beneficial for network exception identification.

### Embodiment 12

An embodiment provides a network node. Referring to FIG. 13, the network node includes: a receiver 1301, a processor 1302, and a transmitter 1303.

The receiver 1301 is configured to receive a service request of a test service, where the service request includes test indication information, the test indication information is used to instruct at least one network node to send service running information of the test service to a service quality processing node during running of the test service, and the service running information includes a time point at which a service message of the test service arrives at the at least one network node or a time point at which a service message of the test service is sent by the at least one network node; and the processor 1302 is configured to send, in response to the service request, the service running information to the service quality processing node during running of the test service.

Further, the service request further includes the following fields: a destination address of a server, a service type, and a UE ID, where the destination address may be a URL. The service type includes, but is not limited to, video, e-mail, download, and a web page. The UE ID may be an IMEI or an IMSI.

In specific implementation, not only the test indication information may be implemented by adding a field to the service request, but also a new service type may be defined to indicate the service type and the test indication information. For example, in a newly defined service type, first a bits indicate the service type, and last b bits indicate test indication information, where both a and b are integers greater than 0.

Specifically, the network node in this embodiment may be an intermediate network node, or may be a server. The server is configured to provide a service response or a service to the service request initiation device.

Specifically, the test indication information includes a first test identifier or a second test identifier, where the first test identifier is used to instruct the at least one network node to add the service running information to the service message of the test service, and instruct the at least one network node to send the service running information to the service quality processing node by using an interface between one network node of the at least one network node and the service quality processing node or an interface between the service request initiation device and the service quality processing node; and the second test identifier is used to instruct each of the at least one network node to send the service running information to the service quality processing node by using an interface between each of the at least one network node and the service quality processing node.

The processor 1302 is configured to: when the test indication information is the first test identifier, add the service running information to service message of the test service, and send the service running information to the service quality processing node by using the interface between the one network node of the at least one network node and the service quality processing node or the interface between the service request initiation device and the service quality processing node; or when the test indication information is the second test identifier, send the service running information to the service quality processing node by using the interface between the interface between a network node and the service quality processing node.

Further, the test indication information includes: a network node type, and the processor 1302 is configured to: determine whether a network node type of the processor 1302 is the same as the network node type in the test indication information; and when determining that the network node type of the processor 1302 is the same as the network node type in the test indication information, send the service running information to the service quality processing node during running of the test service.

Certainly, it is indicated by using test indication information that which network nodes send service running information; in addition, it may be defined in advance which network nodes send service running information, for example, it is stipulated in a protocol, it is directly set on a network node, or the like. As for whether a network node is enabled to send service running information, an actual need of a service test is considered, and in addition, a processing capability of the network node needs to be considered; for example, a network node that does not support the function is not required to send the service running information.

Further, the test indication information includes: a service message type, where the service message type is used to send the service running information corresponding to the service message type to the service quality processing node, and the service running information corresponding to the service message type includes a time point at which a service message of the service message type arrives at the at least one network node.

The service message refers to all messages during service running, and the service request is one type of service message. For example, a video service not only includes a video data packet, but also includes a monitoring playback control message; each service message has one identifier, where the identifier is used to indicate the service message type.

Further, the transmitter 1303 is configured to send the service request.

In this embodiment of the present invention, when receiving a service request of a test service, a network node sends service running information to a service quality processing node, where the service running information includes a time point at which a service message of the test service arrives at at least one network node or a time point at which a service message of the test service is sent by at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

### Embodiment 13

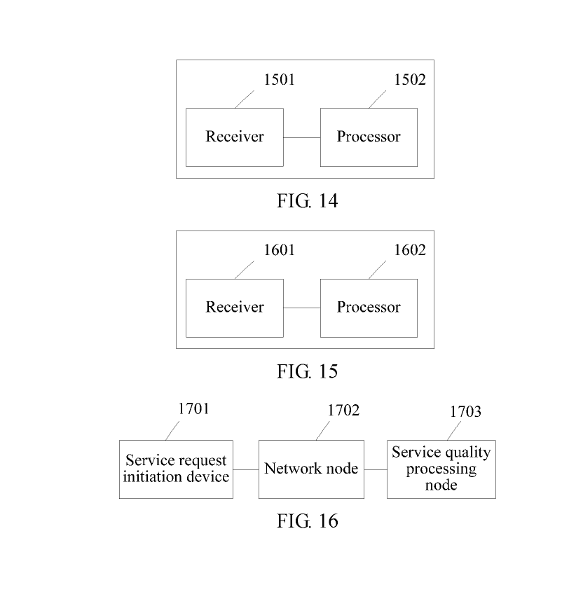

An embodiment provides a service quality processing node. Referring to FIG. 14, the node includes: a receiver 1501, configured to receive service running information of a test service, where the service running information includes a time point at which a service message of the test service arrives at at least one network node or a time point at which a service message of the test service is sent by at least one network node. The node also includes a processor 1502, configured to analyze a network status according to the service running information.

In this embodiment, service running information of a test service is received, where the service running information includes a time point at which a service message of the test service arrives at at least one network node or a time point at which a service message of the test service is sent by at least one network node. Therefore, the time point at which the service message of the test service arrives at the at least one network node is obtained, which avoids a problem in the prior art that only a time point at which service message is initiated and a time point at which the service message arrives can be obtained in a manual dialing test. Service test results are more comprehensive, and are more beneficial for network exception identification.

### Embodiment 14

An embodiment provides a service quality processing node. Referring to FIG. 15, the node includes: a receiver 1601 and a processor 1602, where the receiver 1601 is configured to receive service running information of a test service, where the service running information includes a time point at which a service message of the test service arrives at at least one network node or a time point at which a service message of the test service is sent by at least one network node. The processor 1602 is configured to analyze a network status according to the service running information.

Specifically, the processor 1602 is configured to: determine, according to the service running information, the time point at which the service message of the test service arrives at the at least one network node; calculate a time length between two adjacent time points that are recorded in the service running information, or calculate a time length between one time point that is recorded in the service running information and a time point at which the service message is sent from a service request initiation device or between one time point that is recorded in the service running information and a time point at which the service message arrives at a server; compare the calculated time length with a corresponding preset time length, where the corresponding preset time length refers to a preset time length between two network nodes corresponding to the two adjacent time points, or a preset time length between one network node corresponding to the one time point and a service request initiation device; and when the calculated time length is greater than the corresponding preset time length, determine that a network exception exists between the two network nodes corresponding to the two adjacent time points, or between the one network node corresponding to the one time point and the service request initiation device.

A start time of a service message refers to a time point at which the service message is sent from the service request initiation device or the server, and an arrival time refers to a time point at which the service message arrives at the server or the service request initiation device.

The processor 1602 includes: a determining unit, configured to determine, according to a service type, a preset time length corresponding to the service type, where the preset time length varies according to different service types, for example, between two same network nodes, a preset time length corresponding to a video service is greater than a preset time length corresponding to an e-mail service. The processor 1602 also includes a comparison unit, configured to compare the calculated time length with the corresponding preset time length, where the corresponding preset time length refers to a preset time length that corresponds to the service type and that is between the two network nodes corresponding to the two adjacent time points, or a preset time length that corresponds to the service type and that is between the one network node corresponding to the one time point and the service request initiation device.

For the convenience of understanding, the following gives an example of the method provided in this embodiment: for example, two network nodes A and B exist between the service request initiation device and the server, a preset time length of a video service between A and B is 100 ms, and a preset time length of an e-mail service is 50 ms. Therefore, when the service quality processing node receives service running information of a test service, if the service running information includes a time point at which a service message arrives at A and a time point at which the service message arrives at B, and the time point at which the service message arrives at A and the time point at which the service message arrives at B are adjacent time points, the following processing is performed: a time length between A and B is calculated; a service type is determined, and if in this case, the service type is a video service, it may be obtained that the preset time length is 100 ms; and the calculated time length is compared with 100 ms, and when the calculated time length is greater than 100 ms, it is determined that a network fault exists between A and B.

In this embodiment, service running information of a test service is received, where the service running information includes a time point at which a service message of the test service arrives at at least one network node or a time point at which a service message of the test service is sent by at least one network node. Therefore, the time point at which the service message of the test service arrives at the at least one network node is obtained, which avoids a problem in the prior art that only a time point at which service message is initiated and a time point at which the service message arrives can be obtained in a manual dialing test. Service test result are more comprehensive, and are more beneficial for network exception identification.

### Embodiment 15

An embodiment provides a service testing system. Referring to FIG. 16, the system includes: the service request initiation device 1701 according to Embodiment 9 or Embodiment 10, the network node 1702 according to Embodiment 11 or Embodiment 12, and the service quality processing node 1703 according to Embodiment 13 or Embodiment 14.

In this embodiment, a service request initiation device sends a service request, where the service request includes test indication information, the test indication information is used to instruct at least one network node during running of a test service to send service running information of the test service to a service quality processing node, and the service running information includes a time point at which a service message of the test service arrives at the at least one network node or a time point at which a service message of the test service is sent by the at least one network node. Therefore, the service quality processing node can obtain the time point at which the service message of the test service arrives at the at least one network node, which avoids a problem in the prior art that only a time point at which service message is initiated and a time point at which the service message arrives can be obtained in a manual dialing test. Service test results are more comprehensive, and are more beneficial for network exception identification.

It should be noted that the division of the foregoing function modules is only described for exemplary purposes during a service test for the service request initiation device, the network node, and the service quality processing node that are provided in the foregoing embodiments. In actual application, the functions may be allocated to different function modules and implemented according to a specific requirement, which means that the internal structure of the device is divided into different function modules to implement all or some of the functions described above. In addition, the service request initiation device, the network node, and the service quality processing node that are provided in the foregoing embodiments are based on the same concept as that in the embodiments of the service testing method. For a specific implementation process of the service request initiation device, the network node, and the service quality processing node, refer to the method embodiments, and details are not described herein again.

The sequence numbers of the foregoing embodiments of the present invention are merely for illustrative purposes, and are not intended to indicate priorities of the embodiments.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, an optical disc, or the like.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A method, comprising:
generating, by a service request initiation device, a service request of a test service, wherein the service request comprises test indication information, the test indication information instructs a network node to send service running information of the test service to a service quality processing node during running of the test service, and the service running information comprises a time point at which a service message of the test service arrives at the network node or a time point at which the service message of the test service is sent by the network node; and
sending, by the service request initiation device, the service request to the network node.

2. The method according to claim 1, wherein the test indication information comprises a first test identifier;
wherein the first test identifier instructs the network node to add the service running information to the service message of the test service, and instructs the network node to send the service running information to the service quality processing node using an interface between the network node and the service quality processing node.

3. The method according to claim 1, wherein the test indication information comprises a first test identifier, or a second test identifier;
wherein the second test identifier instructs the network node to send the service running information to the service quality processing node using an interface between the network node and the service quality processing node.

4. The method according to claim 1, wherein the test indication information comprises: a network node type, wherein the network node type instructs the network node corresponding to the network node type to send the service running information to the service quality processing node.

5. The method according to claim 1, wherein the test indication information comprises a service message type, wherein the service message type instructs the network node to send the service running information corresponding to the service message type to the service quality processing node, and the service running information corresponding to the service message type comprises a time point at which a service message of the service message type arrives at the network node.

6. A device, comprising:
a processor, configured to generate a service request of a test service, wherein the service request comprises test indication information, the test indication information instructs a network node to send service running information of the test service to a service quality processing node during running of the test service, and the service running information comprises a time point at which a service message of the test service arrives at the network node or a time point at which the service message of the test service is sent by the network node; and
a transmitter, configured to send the service request to the network node.

7. The device according to claim 6, wherein the test indication information comprises a first test identifier;
wherein the first test identifier instructs the network node to add the service running information to the service message of the test service, and instructs the network node to send the service running information to the service quality processing node using an interface between the network node and the service quality processing node.

8. The device according to claim 6, wherein the test indication information comprises a first test identifier;
wherein the first test identifier instructs the network node to add the service running information to the service message of the test service, and instructs the network node to send the service running information to the service quality processing node using an interface between the device and the service quality processing node.

9. The device according to claim 6, wherein the test indication information comprises a second test identifier;
wherein the second test identifier instructs the network node to send the service running information to the service quality processing node using an interface between the network node and the service quality processing node.

10. The device according to claim 6, wherein the test indication information comprises a network node type, wherein the network node type instructs the network node corresponding to the network node type to send the service running information to the service quality processing node.

11. The device according to claim 6, wherein the test indication information comprises: a service message type, wherein the service message type instructs the network node to send the service running information corresponding to the service message type to the service quality processing node, and the service running information corresponding to the service message type comprises a time point at which a service message of the service message type arrives at the network node.

12. A system, comprising a service request initiation device, a plurality of network nodes, and a service quality processing node;
wherein the service request initiation device is configured to:
generate a service request of a test service, wherein the service request comprises test indication information; and
send the service request to a first network node of the plurality of network nodes, wherein the test indication information instructs the first network node to send service running information of the test service to a service quality processing node during running of the test service;
wherein the first network node is configured to:
receive the service request during running of a test service; and
send the service running information to the service quality processing node, wherein the service running information comprises a time point at which a service message of the test service arrives at the first network node or a time point at which a service message of the test service is sent by the first network node;
wherein the service quality processing node is configured to:
receive the service running information;
determine, according to the service running information, the time point at which the service message of the test service arrives at the first network node;
calculate a time length between two adjacent time points that are recorded in the service running information, or calculate a time length between one time point that is recorded in the service running information and a time point at which the service message is sent from a service request initiation device or between one time point that is recorded in the service running information and a time point at which the service message arrives at a server;
compare, the calculated time length with a corresponding preset time length, wherein the corresponding preset time length refers to a preset time length between two network nodes of the plurality of network nodes corresponding to the two adjacent time points, or a preset time length between one network node of the plurality of network nodes corresponding to the one time point and a service request initiation device; and
in response to the calculated time length being greater than the corresponding preset time length, determine that a network exception exists between the two network nodes corresponding to the two adjacent time points, or between the one network node corresponding to the one time point and the service request initiation device or the server.

13. The system according to claim 12, wherein:
the test indication information comprises a first test identifier, and the first test identifier instructs the first network node to add the service running information to the service message of the test service, and instructs the first network node to send the service running information to the service quality processing node using an interface between one network node of the plurality of network nodes and the service quality processing node;
the first network node is further configured to add the service running information to service message of the test service, and send the service running information to the service quality processing node by using the interface between one network node of the plurality of network nodes and the service quality processing node.

14. The system according to claim 12, wherein,
the test indication information comprises a second test identifier, and the second test identifier instructs each of the plurality of network nodes to send the service running information to the service quality processing node using an interface between each of the plurality of network nodes and the service quality processing node; and
the first network node is configured to: send the service running information to the service quality processing node by using the interface between each of the plurality of network nodes and the service quality processing node.

15. The system according to claim 12, wherein:
the test indication information comprises a network node type;
the first network node is configured to determine whether a network node type of the first network node is the same as the network node type in the test indication information; and
a network node of the plurality of network nodes whose network node type is the same as the network node type indicated by the test indication information during running of the test service is configured to send the service running information to the service quality processing node.

16. The system according to claim 12, wherein:
the test indication information comprises: a service message type; and
the first network node is configured to send the service running information corresponding to the service message type to the service quality processing node, wherein the service running information corresponding to the service message type comprises a time point at which a service message of the service message type arrives at the first network node.

17. The system according to claim 12, wherein the service quality processing node is configured to:
determine, according to a service type, a preset time length corresponding to the service type; and
compare, the calculated time length with the corresponding preset time length, wherein the corresponding preset time length refers to the preset time length that corresponds to the service type and that is between the two network nodes corresponding to the two adjacent time points, or a preset time length that corresponds to the service type and that is between the one network node corresponding to the one time point and the service request initiation device.
